(19) United States
(12) Patent Application Publication
(10) Pub. No.: US 2014/0210439 A1
(43) Pub. Date: Jul. 31, 2014

(54) Switching Regulator and Control Circuit Thereof

(71) Applicants: Tzu-Huan Chiu, Taichung City (TW); Chung-Lung Pai, Hsinchu City (TW); Hung-Yu Cheng, Taipei City (TW); Shuo-Wen Chang, Kaohsiung City (TW)

(72) Inventors: Tzu-Huan Chiu, Taichung City (TW); Chung-Lung Pai, Hsinchu City (TW); Hung-Yu Cheng, Taipei City (TW); Shuo-Wen Chang, Kaohsiung City (TW)

(73) Assignee: Richtek Technology Corporation

(21) Appl. No.: 13/752,881

(22) Filed: Jan. 29, 2013

(51) Int. Cl. G05F 1/10

(52) U.S. Cl. CPC G05F 1/10
USPC 323/274; 323/284

(57) ABSTRACT

The present invention discloses a switching regulator and a control circuit thereof. The switching regulator includes a boost or buck-boost power stage, a first operation circuit and a bypass circuit. The power stage controls at least one power transistor switch included therein according to a first operation signal, to convert an input voltage to an output voltage at an output terminal. The first operation circuit generates the first operation signal in response to the output voltage or a related signal thereof. The bypass circuit includes a bypass transistor and a second operation circuit. When it is required to provide power to the output terminal promptly, the second operation circuit turns ON the bypass transistor, and when the input voltage is equal to the output voltage or equal to a sum of the output voltage plus a safety offset value, the second operation circuit turns OFF the bypass transistor.

### BACKGROUND OF THE INVENTION

1. Field of Invention

The present invention relates to a switching regulator and a control circuit of a switching regulator; particularly, it relates to such switching regulator and control circuit having an improved slew rate of voltage transition.

2. Description of Related Art

In earlier prior art to supply power to a portable electronic device, it is usual to adopt buck conversion. That is, a higher input voltage supplied by a battery is converted to a lower output voltage to power the portable electronic device. Such buck conversion between the input voltage and the output voltage can be achieved by, e.g., a buck switching regulator.

In recent prior art, with the development and the improvement of the battery technology, the battery voltage is capable of supplying power even though it is quite low. Under such circumstance, because the battery voltage is lower than the desired supply voltage, it is required to adopt a boost switching regulator to convert a lower input voltage to a higher output voltage.

A typical boost switching regulator is shown in FIG. 1. The boost switching regulator 1 comprises two power transistor switches QA and QB which are controlled by a control circuit 12. The control circuit 12 generates an ON/OFF control signal in response to a feedback signal FB generated from an output terminal OUT to control the ON/OFF of the power transistor switches QA and QB, so that power is delivered from an input terminal IN to the output terminal OUT to convert an input voltage Vin to an output voltage to power a load 19. The load 19 is, for example but not limited to, a power amplifier in a portable electronic device. FIG. 2 shows the internal structure of the control circuit 12. An error amplifier 16 compares the feedback signal FB with a reference voltage Vref to generate an error amplification signal V_{EA}. A pulse width modulation (PWM) comparator 17 then compares this error amplification signal V_{EA} with a sawtooth signal to generate a PWM signal. A driver circuit 18 converts the PWM signal to a level capable of driving the power transistor switches QA and QB in FIG. 1. According to the principle of feedback control, when the circuit is at a balance state, the feedback signal FB will be equal to or have a known relationship with the reference voltage Vref. Therefore, by adjusting the reference voltage Vref the desired level of the output voltage Vout correspondingly changes. The control mode of the switching regulator shown in FIG. 2 is voltage mode. A current mode switching regulator is also well known to those skilled in the art which operates by a similar principle except that the sawtooth signal is replaced by a current detection signal, and the details thereof are therefore not redundantly repeated here.

In addition to the boost switching regulator shown in FIG. 1, the prior art also proposes a buck-boost switching regulator, as shown in FIG. 3. The buck-boost switching regulator 3 comprises four power transistor switches QA-QD. The buck-boost switching regulator 3 is capable of providing power to the load 19 no matter the input voltage is higher or lower than the output voltage, because the buck-boost switching regulator 3 can operate under a buck mode and a boost mode by switching ON/OFF of the four power transistor switches QA-QD.

The switching regulators shown in FIG. 1 and FIG. 3 are synchronous switching regulators. If one or more of the power transistor switches are replaced by diodes, they will become asynchronous switching regulators. For example, the power transistor switch QB of FIG. 1 can be replaced by a diode or the power transistor switch QB and/or QD of FIG. 3 can be replaced by a diode/diodes. Please refer to an asynchronous switching regulator 3a shown in FIG. 4 for the latter case.

The drawback of the above-mentioned prior art circuits is: the current supplied from the boost switching regulator is relatively low (the buck-boost switching regulator operating under the boost mode has the same problem). The reason is that, during a part of one cycle period of the boost conversion, the current flows from the input terminal Vin through the power transistor switch QA to ground. Hence, when the load 19 transits from stand-by to normal operation and requires higher voltage and current, the response time for converting the input voltage Vin to the desired output voltage Vout is not fast enough. For example, referring to FIG. 5, a slew rate required by a Global System for Mobile Communications (GSM) specification is: from the time point when the load 19 starts requesting a higher voltage (as shown by the change of the reference voltage) to the time point when the output voltage Vout reaches a desired level, the response time in between should be not longer than T1. However, in the above-mentioned prior art circuits, the output voltage Vout fails to reach the desired level within the period of T1 but reaches the desired level after a much longer period of T2. This drawback of the prior art circuits should be overcome.

In view of the above, to overcome the drawback in the prior art, the present invention proposes a switching regulator and a control circuit of a switching regulator having an improved slew rate of voltage transition.

### SUMMARY OF THE INVENTION

A first objective of the present invention is to provide a switching regulator.

A second objective of the present invention is to provide a control circuit of a switching regulator.

To achieve the above and other objectives, from one perspective, the present invention provides a switching regulator, comprising: a boost or buck-boost power stage for controlling at least one power switch included therein according to a first operation signal, to convert an input voltage to an output voltage at an output terminal; a first operation circuit for generating the first operation signal in response to the output voltage or a related signal thereof; and a bypass circuit including a bypass transistor and a second operation circuit, wherein when it is required to provide power to the output terminal promptly, the second operation circuit turns ON the bypass transistor, and when the input voltage is equal to the output voltage or equal to a sum of the output voltage plus a safety offset value, the second operation circuit turns OFF the bypass transistor.

From another perspective, the present invention provides a control circuit of a switching regulator, for controlling a boost or buck-boost power stage to convert an input voltage to an output voltage at an output terminal, the control circuit comprising: a first operation circuit for generating a first operation signal in response to the output voltage or a related signal thereof; and a bypass circuit including a bypass transistor and a second operation circuit, wherein when it is required to provide power to the output terminal promptly, the second operation circuit turns ON the bypass transistor, and when the input voltage is equal to the output voltage or equal to a sum of the output voltage plus a safety offset value, the second operation circuit turns OFF the bypass transistor.

In one embodiment, the bypass transistor includes a transistor having a parasitic diode whose polarity is adjustable. In another embodiment, the bypass transistor includes two transistors connected in series, each one of which has a parasitic diode whose polarity is opposite to the other.

In one embodiment, the first operation circuit generates the first operation signal in response to a relationship between the output voltage or a related signal thereof and a reference voltage, and the switching regulator further comprising: a reference voltage setting circuit for determining the reference voltage according to a setting signal.

In one embodiment, the second operation circuit turns ON the bypass transistor according to one or more of the following judgment factors: a level change of the reference voltage, the setting signal received by the reference voltage setting circuit, a level of the output voltage, or a relationship between the input voltage and the output voltage.

In one embodiment, the second operation circuit turns OFF the bypass transistor according to one or more of the following judgment factors: a level of the output voltage, or a relationship between the input voltage and the output voltage.

In one embodiment, the bypass circuit includes a low drop out (LDO) regulator.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a conventional boost switching regulator.

FIG. 2 shows a schematic diagram of an internal structure of a conventional control circuit.

FIG. 3 shows a schematic diagram of a conventional synchronous buck-boost switching regulator.

FIG. 4 shows a schematic diagram of a conventional asynchronous buck-boost switching regulator.

FIG. 5 shows the voltage transition slew rate in the prior art.

FIG. 6 shows a schematic diagram of a switching regulator according to an embodiment of the present invention.

FIGS. 7A-7F show several embodiments of the power stage.

FIG. 8 shows the voltage transition slew rate of the present invention.

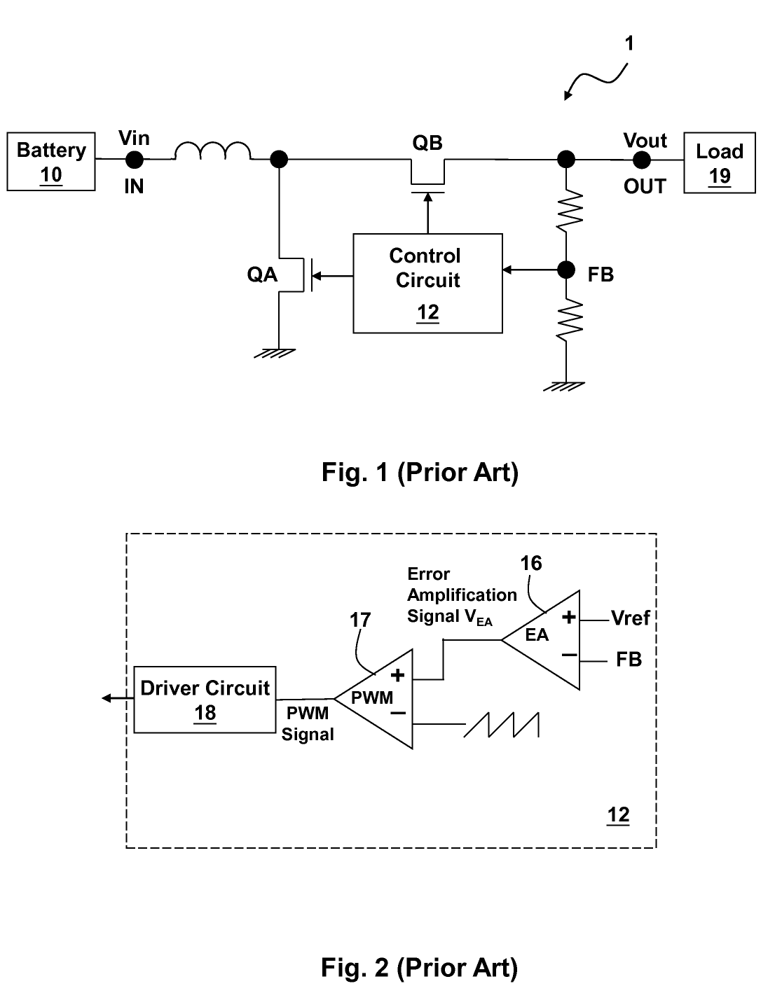

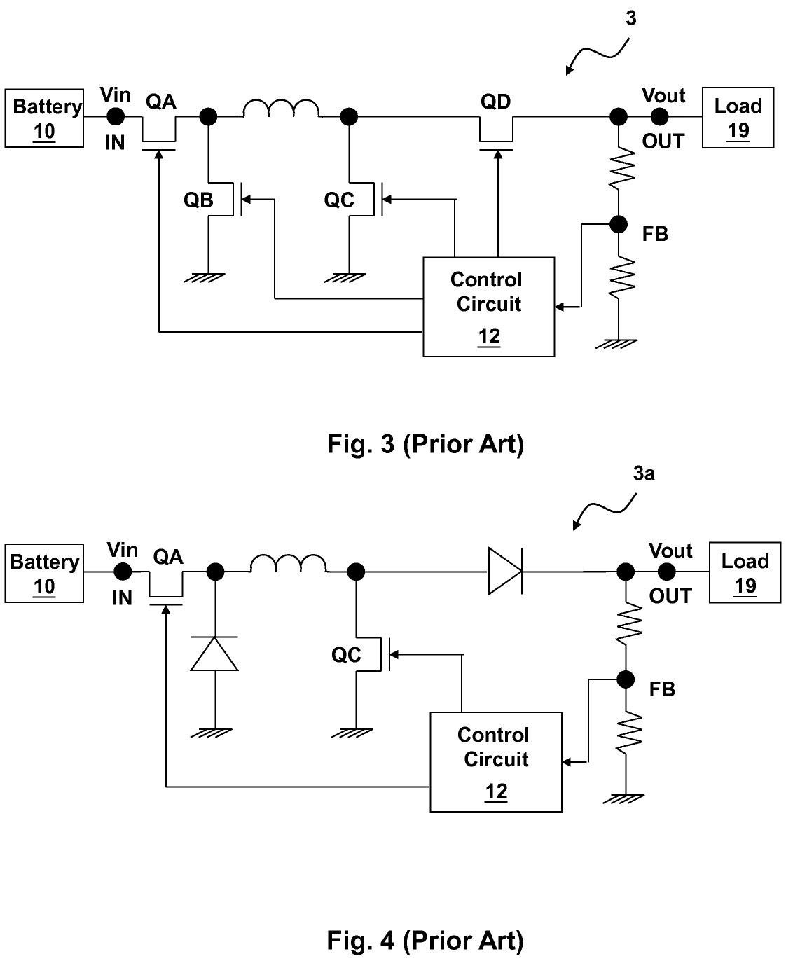

### DESCRIPTION OF THE PREFERRED EMBODIMENTS

The above and other technical details, features and effects of the present invention will be better understood with regard to the detailed description of the embodiments below, with reference to the drawings. In the description, the words related to directions such as “upper”, “lower”, “left”, “right”, “forward”, “backward”, etc. are used to illustrate relative orientations in the drawings and should not be considered as limiting in any way. The drawings as referred to throughout the description of the present invention are for illustration only, to show the interrelations between the apparatus and the devices, but not drawn according to actual scale.

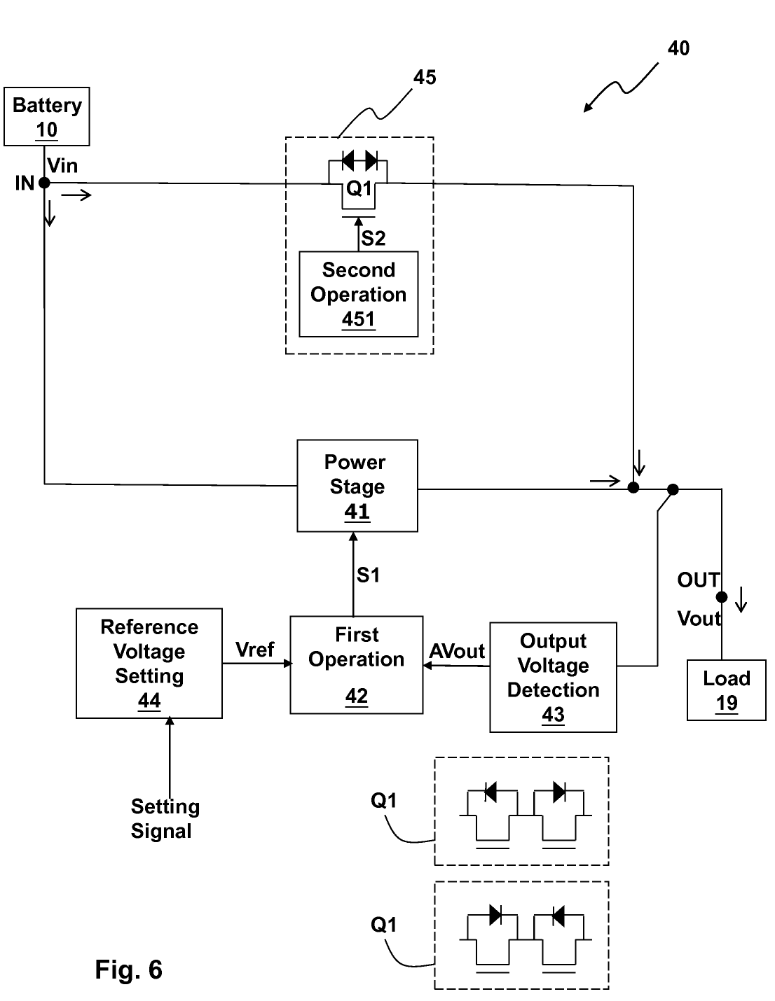

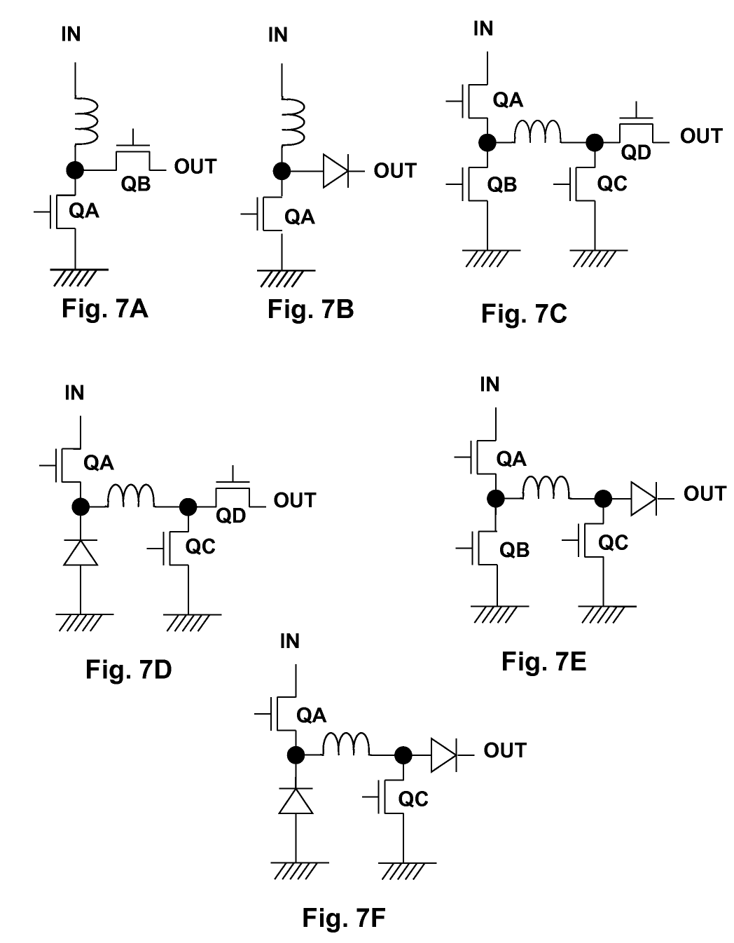

Please refer to FIG. 6, which shows a schematic diagram of a switching regulator according to an embodiment of the present invention. The switching regulator 40 of this embodiment comprises a power stage 41, a first operation circuit 42, an output voltage detection circuit 43, a reference voltage setting circuit 44 and a bypass circuit 45. The power stage 41 of this embodiment can be a synchronous or asynchronous boost switching regulator shown in FIGS. 7A-7B, or a synchronous or asynchronous buck-boost switching regulator shown in FIGS. 7C-7F. Thus, the switching regulator 40 of this embodiment can be a boost switching regulator or a buck-boost switching regulator.

The output voltage detection circuit 43 is coupled to an output terminal OUT; it detects the output voltage Vout and generates a signal AVout related to the output voltage. The output voltage detection circuit 43 can be, for example, a resistor divider circuit. Or, if the level of the output voltage Vout can be directly processed by the first operation circuit 42, the output voltage detection circuit 43 can be omitted and the first operation circuit 42 can directly receive the output voltage Vout. The first operation circuit 42 generates a first operation signal S1 in response to the output voltage related signal AVout to control the operation of the power transistor switches included in the power stage 41, thereby controlling the conversion between the input voltage Vin and the output voltage Vout. The first operation circuit 42 can be, for example but not limited to, the circuit shown in FIG. 2. The reference voltage setting circuit 44 is for adjusting the reference voltage Vref in the first operation circuit 42 according to a setting signal, so as to corresponding adjust a desired level of the output voltage Vout. If it is not necessary to adjust the reference voltage Vref in the application that the switching regulator 40 is applied to, the reference voltage setting circuit 44 can be omitted.

All or some of the first operation circuit 42, the output voltage detection circuit 43, the reference voltage setting circuit 44, the bypass circuit 45 and the power transistor switches of the power stage 41 can be integrated into a control circuit by a semiconductor integrated circuit manufacturing process.

In this embodiment, when the load 19 transits from stand-by to normal operation, the output voltage Vout is correspondingly required to transit from a lower level to a higher level within a short time period. Under such circumstance, the switching regulator 40, on one hand, converts the input voltage Vin to the output voltage Vout through the power stage 41, and, on the other hand, directly supplies power from the input terminal IN to the output terminal OUT through the bypass circuit 45.

In this embodiment, the bypass circuit 45 includes, for example, a bypass transistor Q1 and a second operation circuit 451. When it is required to provide power to the output terminal OUT promptly, the second operation circuit 451 generates a second operation signal S2 to turn ON the bypass transistor Q1. It should be noted that when the load 19 is in normal operation, the conversion from the input voltage Vin to the output voltage Vout is a boost operation where the input voltage Vin is lower than the output voltage Vout. Therefore, it is not feasible to supply power from the input terminal IN to the output terminal OUT by simply turning ON the bypass transistor Q1 in normal operation. The second operation circuit 451 turns ON the bypass transistor Q1 only when the input voltage Vin is higher than the output voltage Vout and turns OFF the bypass transistor Q1 when the input voltage Vin is equal to the output voltage Vout. Preferably, for better circuit control, it will be safer if the second operation circuit 451 turns OFF the bypass transistor Q1 when the input voltage Vin is not yet, but is about to be, equal to the output voltage Vout (i.e., when the input voltage Vin is slightly higher than the output voltage Vout, which can be expressed as: Vin=Vout+ΔV, where ΔV can be a safety offset value determined by the designer).

The conduction of the bypass transistor Q1 can be determined according to, for example, one or more of the following judgment factors: a level change of the reference voltage Vref, the setting signal received by the reference voltage setting circuit 44, a level of the output voltage Vout, or a relationship between the input voltage Vin and the output voltage Vout. Specifically, for example, if the level change of the reference voltage Vref or the setting signal received by the reference voltage setting circuit 44 indicates that the output voltage Vout is required to be raised from a lower level to a higher level, the bypass transistor Q1 can be turned ON. For another example, if the level of the output voltage Vout is lower than a certain level (which can be determined by comparing the output voltage Vout or its related signal AVout with a reference level), the bypass transistor Q1 can be turned ON. For yet another example, when the output voltage Vout is lower than the input voltage Vin (which can be determined by comparing the output voltage Vout or its related signal AVout with the input voltage Vin or its related signal), the bypass transistor Q1 can also be turned ON. In the last example (i.e., when the output voltage Vout is lower than the input voltage Vin), it is needed to know the relative relationship between the output voltage Vout and the input voltage Vin. To do so, a voltage detection circuit (e.g., a resistor divider circuit) can be employed to obtain a signal representing the input voltage Vin, or the second operation circuit 451 can directly receive the input voltage Vin, so that both information of the input voltage Vin and the output voltage Vout are obtained. The second operation circuit 451 can be design according to how it determines to control the conduction of the bypass transistor Q1. The bypass transistor Q1 is not limited to be fully conductive and the bypass circuit 45 can be, for example but not limited to, a low drop out (LDO) regulator.

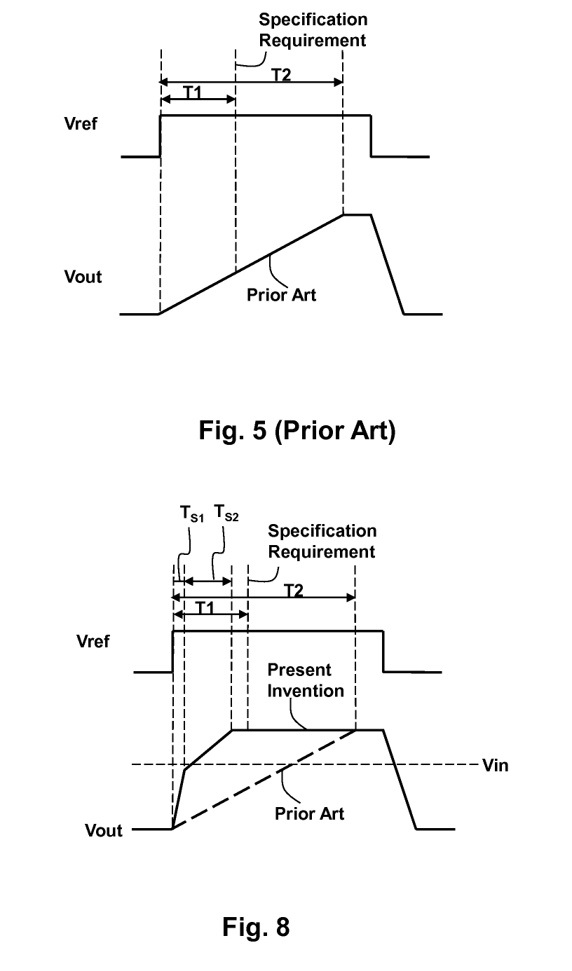

Please refer to FIG. 8 (under FIG. 5), when it is required to supply power to the output terminal OUT promptly (which is determined by, for example, the level change of the reference voltage Vref), the present invention responds to the requirement and raises the output voltage Vout to a level equal to or near to the input voltage Vin during a very short period of TS1 through the bypass circuit 45 (during this period, the power stage 41 can either operate or not operate; however, if the power stage 41 operates, the rising speed of the output voltage Vout will be faster). During the period of TS2, when the output voltage Vout is equal to or near to the input voltage Vin, the bypass transistor Q1 can be turned OFF (the time point for turning OFF the bypass transistor Q1 can be determined according to the level of the output voltage Vout, or the relationship between the input voltage Vin and the output voltage Vout), and the switching regulator 40 converts the input voltage Vin to the output voltage Vout through the power stage 41. As a consequence, the total time period for the present invention to convert the input voltage Vin to the output voltage Vout, i.e., the sum of TS1 and TS2, is shorter than the time period of T1 required by the GSM specification and the time period of T2 required by the prior art. That is, the switching regulator 40 can meet the slew rate requirement of the GSM specification and is superior to the prior art.

It is noteworthy that because the relative relationship between the level of the input voltage Vin and the level of the output voltage Vout is not fixed, the design of the bypass transistor Q1 should take this into consideration. For example, the bypass transistor Q1 of this embodiment can be a transistor having a parasitic diode whose polarity is adjustable, as shown in FIG. 6. In another embodiment, the bypass transistor Q1 can include two transistors connected in series, each one of which has a parasitic diode whose polarity is opposite to the other, as shown in the lower part of FIG. 6. That is, the second operation signal S2 generated by the second operation circuit 451 controls the two transistors connected in series, or, the second operation circuit 451 at least controls the transistor having the parasitic diode whose polarity is opposite to the current direction.

It should be noted that the present invention is not limited to overcoming the prior art's drawback of not meeting the requirement of the GSM specification. For example, under the circumstance where the reference voltage Vref is a constant (in this case it does not require the reference voltage setting circuit), in a start-up or re-boot operation, or in a case wherein the load suddenly consumes high power so that the output voltage Vout suddenly drops low, the present invention can also enable the output voltage Vout to reach the desired level much faster.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, a device which does not substantially influence the primary function of a signal can be inserted between any two devices in the shown embodiments, such as a switch. For another example, each of the power transistor switches QA-QD and the bypass transistor Q1 can be a PMOS or an NMOS. For yet another example, the second operation circuit 451 can be integrated into the first operation circuit 42 and it does not need to be a stand-alone circuit. In view of the foregoing, the spirit of the present invention should cover all such and other modifications and variations, which should be interpreted to fall within the scope of the following claims and their equivalents.

What is claimed is:

1. A switching regulator, comprising:
a boost or buck-boost power stage for controlling at least one power transistor switch included therein according to a first operation signal, to convert an input voltage to an output voltage at an output terminal;
a first operation circuit for generating the first operation signal in response to the output voltage or a related signal thereof; and
a bypass circuit including a bypass transistor and a second operation circuit, wherein when it is required to provide power to the output terminal promptly, the second operation circuit turns ON the bypass transistor, and when the input voltage is equal to the output voltage or equal to a sum of the output voltage plus a safety offset value, the second operation circuit turns OFF the bypass transistor.

2. The switching regulator of claim 1, wherein the bypass transistor includes a transistor having a parasitic diode whose polarity is adjustable, or includes two transistors connected in series, wherein each one of the two transistors connected in series has a parasitic diode whose polarity is opposite to the other.

3. The switching regulator of claim 1, wherein the first operation circuit generates the first operation signal in response to a relationship between the output voltage or a related signal thereof and a reference voltage, and the switching regulator further comprising:
a reference voltage setting circuit for determining the reference voltage according to a setting signal.

4. The switching regulator of claim 3, wherein the second operation circuit turns ON the bypass transistor according to one or more of the following judgment factors: a level change of the reference voltage, the setting signal received by the reference voltage setting circuit, a level of the output voltage, or a relationship between the input voltage and the output voltage.

5. The switching regulator of claim 1, wherein the first operation circuit generates the first operation signal in response to a relationship between the output voltage or the related signal thereof and a reference voltage, and the second operation circuit turns ON the bypass transistor according to one or more of the following judgment factors: a level change of the reference voltage, a level of the output voltage, or a relationship between the input voltage and the output voltage.

6. The switching regulator of claim 1, wherein the second operation circuit turns OFF the bypass transistor according to one or more of the following judgment factors: a level of the output voltage, or a relationship between the input voltage and the output voltage.

7. The switching regulator of claim 1, wherein the bypass circuit includes a low drop out (LDO) regulator.

8. A control circuit of a switching regulator, for controlling a boost or buck-boost power stage to convert an input voltage to an output voltage at an output terminal, the control circuit comprising:
a first operation circuit for generating a first operation signal in response to the output voltage or a related signal thereof; and
a bypass circuit including a bypass transistor and a second operation circuit, wherein when it is required to provide power to the output terminal promptly, the second operation circuit turns ON the bypass transistor, and when the input voltage is equal to the output voltage or equal to a sum of the output voltage plus a safety offset value, the second operation circuit turns OFF the bypass transistor.

9. The control circuit of claim 8, wherein the bypass transistor includes a transistor having a parasitic diode whose polarity is adjustable, or includes two transistors connected in series, wherein each one of the two transistors connected in series has a parasitic diode whose polarity is opposite to the other.

10. The control circuit of claim 8, wherein the first operation circuit generates the first operation signal in response to a relationship between the output voltage or a related signal thereof and a reference voltage, and the switching regulator further comprising:
a reference voltage setting circuit for determining the reference voltage according to a setting signal.

11. The control circuit of claim 10, wherein the second operation circuit turns ON the bypass transistor according to one or more of the following judgment factors: a level change of the reference voltage, the setting signal received by the reference voltage setting circuit, a level of the output voltage, or a relationship between the input voltage and the output voltage.

12. The control circuit of claim 8, wherein the first operation circuit generates the first operation signal in response to a relationship between the output voltage or a related signal thereof and a reference voltage, and the second operation circuit turns ON the bypass transistor according to one or more of the following judgment factors: a level change of the reference voltage, a level of the output voltage, or a relationship between the input voltage and the output voltage.

13. The control circuit of claim 8, wherein the second operation circuit turns OFF the bypass transistor according to one or more of the following judgment factors: a level of the output voltage, or a relationship between the input voltage and the output voltage.

14. The control circuit of claim 8, wherein the bypass circuit includes a low drop out (LDO) regulator.
